(19) United States
(12) Patent Application Publication
(10) Pub. No.: US 2024/0311383 A1
(43) Pub. Date: Sep. 19, 2024

(54) AUTOMATIC DOCUMENT RANKING FOR COMPUTER ASSISTED INNOVATION

(71) Applicant: Dell Products L.P., Round Rock, TX (US)

(72) Inventors: Iam Palatnik de Sousa, Rio de Janeiro (BR); Alexander Eulalio Robles Robles, Valinhos (BR); Werner Spolidoro Freund, Rio de Janeiro (BR)

(21) Appl. No.: 18/183,847

(22) Filed: Mar. 14, 2023

(51) Int. Cl. G06F 16/2457; G06F 16/93; G06F 16/953

(52) U.S. Cl. CPC G06F 16/24578; G06F 16/93; G06F 16/953

(57) ABSTRACT

One example method includes receiving input from a user, the input including reference information, and a document corpus that comprises a group of documents, performing a byte pair encoding (BPE) process, and/or preprocessing, on the documents in the document corpus, so as to generate a respective TDF-IDF (term frequency-inverse document frequency) vector for each of the documents in the document corpus, comparing each of the TDF-IDF vectors to the reference information, and based on the comparing, ranking the documents according to their respective relevance to the reference information.

### FIELD OF THE INVENTION

Embodiments of the present invention generally relate to identifying search results relevant to a query. More particularly, at least some embodiments of the invention relate to systems, hardware, software, computer-readable media, and methods, for ranking documents and other information that are most relevant to a specified document or other group of information.

### BACKGROUND

In order to achieve innovation, researchers must be constantly up to date with the literature that pertains the most to their particular studies and projects. Because research efforts generally focus on highly relevant and current topics, the amount of literature to be covered by individual researchers does not scale feasibly in the typical timeframe of a study, typically about 2 to 4 weeks. Modern topics in AI/ML (artificial intelligence/machine learning) can easily have over 5000 potentially relevant papers, with dozens or hundreds of new publications per month depending on the topic. Any such publication can potentially be a pivotal influence on an invention or patent.

Typically, this situation is addressed by researchers by narrowing down the most relevant publications using search engine keywords and syntax, or by subscribing to human curated periodic lists of publication highlights. However, such filtering methods are highly subjective and specific to each particular researcher.

Search engines, moreover, can only impart a small amount of specific context onto the queries, which leaves most of the effort of determining the adherence to a particular area of interest to the researcher. Publication highlights lists also typically focus only on papers that are highly cited or shared in social media, potentially missing out on more niche, but still extremely relevant, publications.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a method according to one example embodiment.

FIG. 2 discloses aspects of a process flow according to one example embodiment.

FIG. 3 discloses an example of a failure experienced when using conventional search techniques.

FIG. 4 discloses an example of results obtained with an embodiment of the invention.

FIG. 5 discloses an example of results obtained with a conventional search approach.

FIG. 6 discloses an example computing entity configured and operable to perform any of the disclosed methods, processes, and operations.

### DETAILED DESCRIPTION OF SOME EXAMPLE EMBODIMENTS

Embodiments of the present invention generally relate to identifying search results relevant to a query. More particularly, at least some embodiments of the invention relate to systems, hardware, software, computer-readable media, and methods, for ranking documents and other information that are most relevant to a specified document or other group of information.

In general, an embodiment of the invention may combine Natural Language Processing (NLP) and AI/ML methods in order to automatically parse and rank a set of publications according to a reference document. In one particular embodiment, a method is provided that may comprise: [1] retrieving a corpus of relevant documents, where a user may provide a query to a publication search engine and receives a set of abstracts and/or full-documents in return; [2] preprocessing the returned documents to provide a numerical representation, where the preprocessing may be performed for example, using a tokenization module, which may be unsupervised, pre-trained, or fine-tuned; [3] extracting, possibly using TF-IDF, features from the preprocessed texts; [4] receiving a reference document, such as from a user, that may serve to contextualize the ranking; and [5] comparing, using a similarity function such as cosine similarity, the features of all the documents to the reference document, and sorting the documents, possibly in descending order of similarity. In an embodiment various reference documents may be used and may include, without limitation, the description of a study/project, the description of a desired application/product, a scientific paper, a standard or other regulatory document, and/or, any relevant text that a user wants to use to bring more context into the ranking.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect is that an embodiment may improve upon conventional search techniques with little, or no, attendant increase in the use of computing resources. As another example, an embodiment may provide a context to results rankings that is much richer, deeper and fine-grained than can be provided by conventional search queries. An embodiment may reduce, or avoid, security problems associated with conventional search processes and systems. Various other advantages of one or more example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. CONTEXT FOR AN EMBODIMENT

Although various approaches may be used to automatically parse literature, the focus of such approaches is on a domain different from a domain contemplated by one or more embodiments of the invention. Namely, those approaches are more focused on finding technology trends in the literature, whereas at least one embodiment of the invention is concerned instead with ranking a set of papers/documents regarding the extent to which those materials are relevant to a given reference document or information provided by a user/researcher.

Search engines, for example, are commonly used for the purpose of finding relevant documents given a set of keywords, but this approach is typically not adequate to impart fine-grained context to a query. While search engines might be good to find, for example, a large set of papers dedicated to “Transformer Architectures,” search engines are ill-suited for finding which among these papers better, and/or best, correlates to a particular initiative, project, study, standard, or other reference information, that is of interest to a user. As an example, a user might wonder which of the thousands of papers returned by the search engine for a “Transformer Architectures” queries best fits their particular product, which has a long description that cannot be passed directly to a search engine as keywords.

Conventional query methods likewise fail to provide adequate results in many contexts and domains. For example, although the idea of querying a set of documents is a very commonly employed method in general, common querying methods, such as SQL and Elastic Search for example, by themselves, do not impart the same level of fine-grained detailed matching that an embodiment of the invention may provide.

### B. OVERVIEW

Recently, there has been a trend toward using Artificial Intelligence (AI) to augment the capabilities of human users in various applications. This approach of computer-assisted applications may be used in and embodiment to solve the scalability issue in literature review for innovation. Thus, one example embodiment comprises an automated method for ranking the publications and documents that are most relevant to a specific study, project or effort that is of interest to a user, using a richer context than what is available by relying solely on a search engine. In this way, a user may be able to parse through thousands of potentially relevant matches in a more scalable way.

As noted earlier herein, an embodiment may combine natural language processing (NLP) and AI/ML methods in order to automatically parse and rank a set of publications according to a reference document and/or other information provided by a user. In one experiment involving an embodiment of the invention, it was noted empirically that the final ranked documents were much more closely aligned to the particular interests of the user than results that could be obtained purely by a search engine query. Thus, an embodiment of the invention may comprise a system and/or method configured and operable to select relevant documents from a catalog based on a complete reference document.

As another example, an embodiment may enable an automated ranking of documents in a specified context, without incurring unreasonable computational costs. The context provided to the ranking is much richer, deeper and fine-grained than commonly used search queries. Further, the use, in an embodiment, of NLP methods in a Tokenizer subroutine further enables the ranking model, according to an embodiment, to use rich representations learned by the AI/ML methods.

Further, an embodiment may enable an inventor, researcher, or other user, to scale up their coverage of relevant literature, decreasing the chance of missing relevant documents that could aid in their process of generating intellectual property, reducing the risk of redundancy, and allowing them to find important sources that might go unnoticed to competitor inventors.

As a final example, an embodiment may implement a sensitivity preserving comparison. Using traditional online APIs to query search engines with deeper context related to particular projects also presents a security problem in that sensitive data could be uploaded in those queries. Thus, in an embodiment, it is possible to only query the online search APIs with basic keywords in the area of interest and perform the deeper contextualized ranking with longer, and potentially sensitive, documents locally and safely, without requiring any external search engine service.

### C. CONCEPTS RELATING TO AN EMBODIMENT OF THE INVENTION

Concepts and techniques relating to an embodiment of the invention may be related to the NLP and AI/ML techniques used. Namely, these concepts and techniques may include preprocessing, tokenization, and byte pair encoding (BPE) and TF-IDF vectorization.

### C.1 Preprocessing

The task of text pre-processing is an area of NLP and may comprise a few steps that are sequentially applied to an input text string. The way in which the text is preprocessed may be important to the subsequent comparison task because it determines what terms are being compared by way of TF-IDF. In the case of an embodiment of the invention, two preprocessing approaches are used, namely, a preprocessing approach comprising tokenization, cleaning and stemming, and a BPE based tokenization. Each process brings out different features from the compared documents. In this case, it is not trivial that either method would consistently outperform the other one in finding most relevant papers, but the methods are computationally inexpensive in this context, such that there is little or no disadvantage in running both methods, and then finding which papers or other information are respectively highlighted by the two methods.

### C.1.1 Tokenization

Although specific implementations vary, one of the operations in text pre-processing is tokenization, that is, splitting a sentence or other string into its smallest constituent parts, which may be referred to as ‘tokens.’ Depending on the application and type of AI/ML model involved, the tokens might be characters, words, or even entire sentences. One common type of tokenization is tokenization into words. For example, a word tokenizer might operate as follows: word tokenizer Input: ‘The cat and the dog’ word tokenizer output: [The, cat, and, the, dog]

As this example illustrates, the word tokenizer has split the string into its constituent words.

### C.1.2 Cleaning

When applying preprocessing for NLP texts, a tokenized string may then be cleaned by lowercasing, and removing certain undesirable substrings such as special symbols, repeated spaces, multiple line skips, or similar. Stop-word removal may also be applied in this step. Stop-words are commonly used tokens that are not very meaningful, but are extremely frequent in a given language. For English, some example stop words might include words such as ‘the,’ ‘at’, and ‘on.’

### C.1.3 Stemming

Words in a text might carry similar meanings or grammatical structures, despite not being exactly equal strings. This could cause an NLP application to focus on unnecessarily detailed differences between words such as ‘computer,’ ‘computerized,’ ‘computational,’ and ‘computing,’ for example. Stemming is the process of reducing these words to a common stem. In this example, the stem might be ‘comp’ or ‘compu.’

### C.1.4 Example

Consider the following example illustration of the application of a pre-processing, where a sentence to be pre-processed is ‘We have unified a large number of approaches.’ Application of a preprocessing approach such as disclosed herein might transform this sentence to ‘unifi larg number approach singl approach.’ It can be seen in this example that tokenization has split the sentence into words, and eliminated the insignificant words, while a stemming processing has reduced a number of the words to respective stems.

### C.2 Byte Pair Encoding (BPE)

A more recent approach that that may reduce, or eliminate, the need for classic tokenization entirely is called Byte Pair Encoding. This is within a class of more recent methods that focus on sub-word strings, rather than trying to tokenize words or characters. In an embodiment, the advantage of using sub-word tokens may be threefold: [1] BPE may solve the problem of stemming similar words without arbitrarily choosing the stems, because BPE is a method where the sub-word tokens are learned, rather than hard-coded; [2] the use of BPE may enable a model to easily parse a word that was not previously seen, eliminating problems with

Out-of-Vocabulary (OOV) terms—consider, for instance, a word such as “TechRadar” or other product names that might not exist in literature-a conventional NLP model would have to assign this word an OOV token, and would struggle to generate meaningful comparisons or representations with it and, similarly, most stemmers would not be well equipped to stem this word-however a model, such as BPE, using sub-word tokens could easily separate the string ‘TechRadar’ into ‘Tech,’ ‘Radar,’ ‘TechRadar’ and several other such substrings; and [3] BPE is especially helpful in languages, such as Chinese or Japanese for example, where the written forms may not have spaces or easy markers to split words.

### C.2.1 BPE Algorithm

With regard to how BPE operates, consider a hypothetical training dataset that comprises a long, raw, unprocessed English text. A first step performed by a BPE algorithm may be to split the text down on the character level, where each character is treated as a symbol. For instance, given an input such as ‘The cat and the dog,’ application of a splitting process might result in the set of symbols ‘T,h,e, ,c,a,t, ,a,n,d, ,t,h,e, ,d,o,g.’ Every time a new symbol is obtained, it may be included in a list referred to as a ‘Vocabulary.’ Note how a space” is treated as a symbol like any other. Note also how capital ‘T’ and lowercase ‘t’ are also treated as different symbols.

After the splitting, then all pairwise combinations of symbols occurring in the text are computed, resulting in the following combinations of symbols ‘Th,’ ‘he,’ e’, ‘c,’ ‘ca’ . . . . The most frequent pair of symbols, ‘he’ in this example, given the input of ‘The cat and the dog,’ is then merged and considered as a new symbol, which is then added to the vocabulary. As such, the following group of symbols may result: ‘T,he, ,c,a,t, ,a,n,d, ,t,he, ,d,o,g’-note that ‘he’ has been added to the vocabulary. If the process were stopped here, the final vocabulary would be [t,h,e,c,a,t,n,d,o,g,he].

In a real application however, this process may be continued and repeated until either the symbols cannot be merged anymore or, more commonly, until a maximum number of merges is achieved, where this maximum number may be set by a user as a hyperparameter for the process. This hyperparameter may be referred to as ‘vocabulary size’ in the related literature. In practice, since NLP models may be trained on very large datasets, the vocabulary sizes often range in the order of magnitude of thousands, to dozens of thousands.

Typically, all the symbols in the vocabulary then receive a corresponding numerical index so that they can be located in the vocabulary. The approach just describe enables a model to learn all the most frequent words, sub-words, and characters, in a given training corpus, directly from raw text without any explicit tokenization or preprocessing.

### C.2.1 Example

Continuing with the same example sentence as before, an embodiment of the invention may unify a number of approaches. The BPE encoder used for the experiments described elsewhere herein may split this sentence into different tokens depending on the size of the BPE vocabulary used. The larger the vocabulary, the more whole English words the vocabulary and processed texts will contain. For example, with vocabulary sizes of 1000, 10,000 and 100,000 respectively, the sentence may be split as follows:

we have un if ied a lar ge number of ap pro ac he s into a sing le ap pro ach (1000)

we have un ified a large number of approaches into a single approach (10,000)

we have unified a large number of approaches into a single approach (100,000)

Note how smaller vocabulary sizes tend to emphasize sub-words, while larger vocabulary sizes tend to emphasize whole-words.

### C.3 TF-IDF Vectorization

As used herein, TF-IDF stands for ‘Term Frequency-Inverse Document Frequency’. TD-IDF is a form of text representation, and is used in machine learning and NLP. The term frequency (tf) refers to the number of times that a word appears within a given document. For instance, if the word ‘cat’ appears 10 times in a 100-word document, the term frequency of ‘cat’ for that document has a value of 10/100=0.1.

The inverse document frequency (idf) concerns the commonness of a word is in all the documents that form a corpus. Considering a corpus with 1000 documents, 100 of which contain the word ‘cat,’ the idf is given by the logarithm (natural) of the ratio of all documents to relevant documents, that is, the documents that concern the word of interest. That is, in this case, the idf would be ln(1000/100)˜ 2.3. Further, the TF-IDF for the word ‘cat’ in that particular document, in that particular corpus, is simply the product [tf×idf], or 0.1*2.3=0.23.

When there is a vocabulary of tokens or symbols, it is possible to compute this TF-IDF quantity for every element in the vocabulary, thus creating a vector that represents each document in the corpus. These vectors may then be compared to each other for similarity by using any vectorial similarity metric.

### D. DETAILED DISCUSSION OF ASPECTS OF AN EMBODIMENT

### D.1 User Input

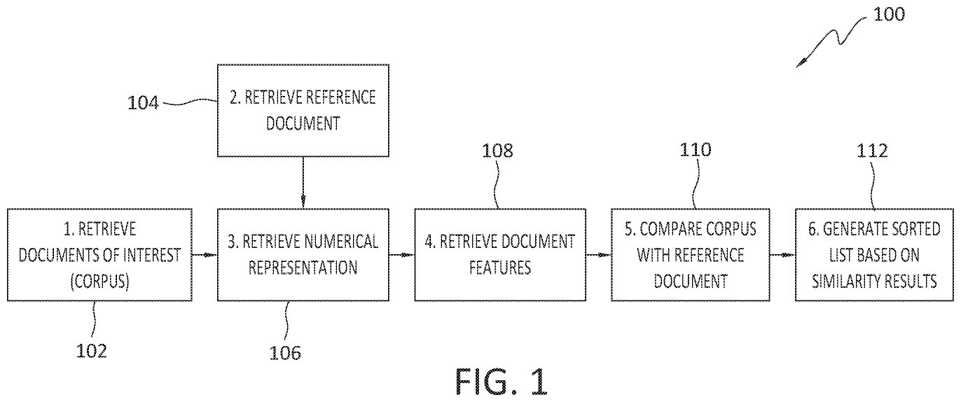

With reference to FIG. 1, there is disclosed an example method 100 according to an embodiment of the invention. The method 100 may assume receipt of two inputs from a user, namely, receipt 102 of a corpus of documents, and receipt 104 of a reference document and/or other information. Note that while reference is made herein to a ‘reference document,’ that term is intended to be broadly construed and is not limited only to documents, or portions of documents, but, more generally, extends to any information, in whatever form, that a user may provide for the purposes of identifying relevant results, as those are defined herein.

In more detail, an example of user input may comprise: [1] several documents of potential interest, where a base query may be used to retrieve documents from a search engine as an example of a possible embodiment—this grouping of documents may be referred to as a corpus; and [2] a reference document to contextualize the query in detail. In an embodiment, the aim, and result, may be to rank the documents of the corpus with regard to the extent to which each found document, that is, found through use of a method according to an embodiment of the invention, matches the reference document. As noted, the concept of ‘document’ herein is intended to be broad and includes, but is not limited to, abstracts, descriptions, full papers, standards, patents, or any other type of text.

### D.2 Retrieve Numerical Representation (Raw Text Processing)

All texts and information received 102 and 104, in the example method 100, may undergo a preprocessing which may comprise a raw text processing 106 as disclosed elsewhere herein. Because it may not be readily apparent, in any particular set of circumstances, whether traditional preprocessing, or BPE, are most likely to produce the best results, and because neither approach is computationally expensive, both approaches may be employed in an embodiment. To illustrate, preprocessing ˜1000 texts takes about 600 ms with BPE, and about 2 seconds with the preprocessing. As another example, in experiments encoding corpora (plural of ‘corpus’) 1000 abstracts, the BPE encoding took approximately 600 milliseconds, even with large vocabularies of size 10,000.

The BPE processing may be performed using the BPEmb open-source library as disclosed in Heinzerling, B. and Strube, M., 2017. BPEmb: Tokenization-free pre-trained subword embeddings in 275 languages. arXiv preprint arXiv:1710.02187, which is incorporated herein in its entirety by this reference. The BPEmb open-source library has several pre-trained BPE vocabularies extracted from very large corpora, typically the full corpora of Wikipedia in various languages. This approach may eliminate the need for a user to extract its own BPE vocabularies, although this could be done as an additional operation, in one embodiment of the invention.

### D.3 Retrieve Document Features

A relevant summary representing the text content may be obtained 108 that may be used to compare the documents. One embodiment of the invention considers the computation of TF-IDF vectors from the pre-trained BPE vocabulary. The total corpus includes all results from the queried search engine and the reference document. There are open-source TF-IDF implementations available that may be used in an embodiment. One particular example embodiment may use the TF-IDF implementation from the Scikit-learn library.

### D.4 Similarity Computation

At 110, the vectorized documents may be compared pairwise with the reference document, and then ranked 112 in a list sorted from highest similarity to lowest, relative to the reference document. In an embodiment, the vectorized documents may be compared with the reference document using cosine similarity as a metric. Any other suitable similarity metric may alternatively be employed however.

### D.5 Further Discussion

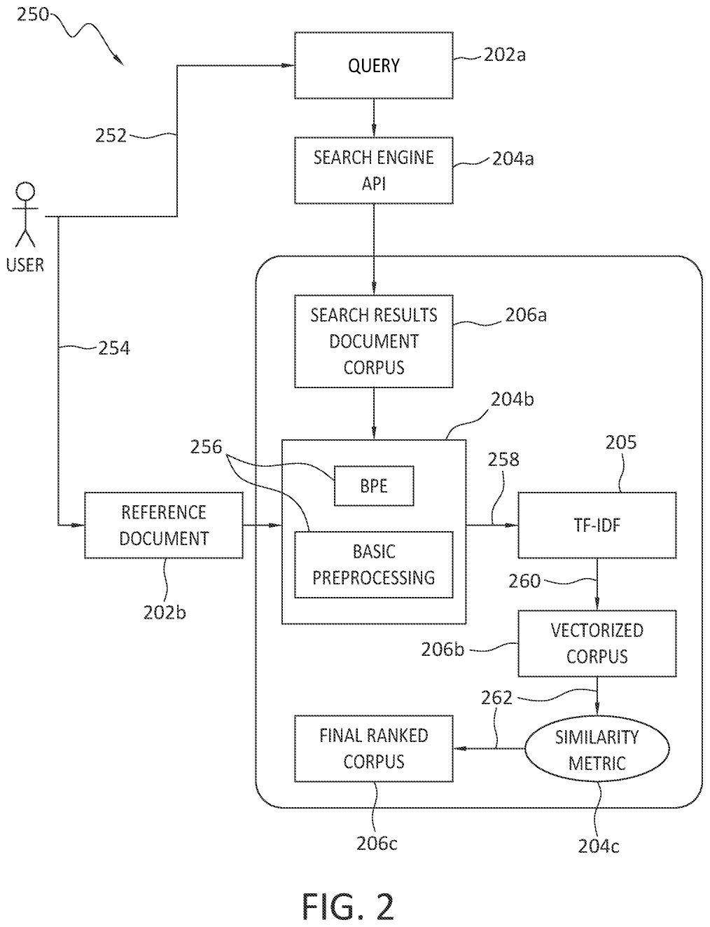

With the general discussion of FIG. 1 in view, attention is directed now to FIG. 2 which discloses various aspects of an embodiment of the invention. In general, the elements 202a and 202b, namely a query and a reference document, comprise inputs that may be provided by a user. The elements 204a, 204b, and 204c, comprise hyperparameters or modules that may be specified, or changed, by the user. For example, a user may specify any or all of: the vocabulary size of the BPE 204b; the language of the pretrained BPE vocabulary chosen 204b; a similarity metric 204c and search engines 204a.

The elements 204a, 204b, and 204c, may be largely fixed for each specific application. For example, in one use case tested by the inventors, the BPE vocabulary was an English pre-trained vocabulary of size 10,000, the similarity metric was cosine-similarity, and the search engine was the arXiv API. These remain fixed throughout all uses of an embodiment, with changes only to the input queries, such as 202a, and reference texts, such as 202b.

Finally, the elements 206a, 206b, and 206c, indicate the corpus of documents at different stages of processing. In particular, the search results document corpus resulting from use of a conventional search engine, for example, is indicated at 206a. The document corpus, after preprocessing 204b, and application of TF-IDF 205, is indicated at 206b, and the final ranked corpus of documents, after comparison using a similarity metric 204c, is indicated at 206c.

With continued reference to FIG. 2, an example method 250 may begin when a user passes 252 a query to a search API (application program interface), and may also pass 254 a reference document, as inputs in an embodiment. The results 206a of the query 202a, and the reference document 202b, may be preprocessed 256 with both preprocessing and BPE, and then passed 258 to the TF-IDF process 205, which may then generate 260 the vectorized corpus 206b, which may comprise TF-IDF vectors. Finally, the TF-IDF factors may be compared 262, such as with a similarity metric, to generate the final ranked corpus 206c.

### E. EXPERIMENTS AND RESULTS

One embodiment of the invention was employed by the inventors in the beginning of recent studies, one of which will be referred to herein as ‘ABCD-1234’ (not the real name), during literature revisions. One of the venues for AI/ML publications is the arXiv, which is an open pre-print server with an already implemented python search API. This particular study focused on finding the links between ‘knowledge graphs’ and ‘zero trust.’

In this example however, a direct search of arXiv is notably very limited in its usefulness and effectiveness. For example, the screenshot 300 in FIG. 2 shows how, with just the few keywords “knowledge graph transformer architecture security,” the arXiv engine is easily overwhelmed and returns no results, even when an attempt is made to provide context by including various search terms. The inventors have consistently observed this behavior whenever multiple keywords, such as in the example just noted, are used for arXiv searches and, as should be apparent, this approach may make it quite difficult to find potentially relevant papers directly within the arXiv.

Notably, arXiv pre-prints are typically also indexed in larger search engines such as Google®. On those larger engines, using search engine semantics makes it possible to obtain better results, even while specifying the search among arXiv-only pages. However Google® and other conventional search engines do not perform well when a very large query is provided, such as using large parts of whole documents as search terms or search strings, and uploading large queries with very specific information can pose a privacy and sensitivity problem in certain circumstances.

In contrast, using an embodiment of the invention, the inventors parsed the abstracts of the 1000 most recently published arXiv papers related to the query ‘transformer architecture,’ and then ranked those papers according to their similarity to the entire description of an internal study from the company.

With reference now to FIG. 4, the screenshot 400 shows the results for another effort that involved the 1000 most recent ‘knowledge graph’ arXiv papers, when compared to the description of the internal study, using BPE with a pretrained vocabulary of size 10000. As shown in the screenshot 400, the best matching result in this example case is the paper ‘KGLM: Integrating Knowledge Graph Structure in Language Models for Link Prediction,’ which describes several utilizations of transformer models as embedding layers for knowledge-graphs in entity relation extractions, which the aforementioned internal study and subsequent studies came to show may be a key part of employing knowledge graphs in cybersecurity applications. Note that, as discussed in more detail below in connection with FIG. 5, using preprocessing instead of BPE still highlights the same paper as the best match to the study.

In particular, the screenshot 500 in FIG. 5 discloses results for the 1000 most recent ‘knowledge graph’ arXiv papers compared to the description of study OCTO-4729, using preprocessing, instead of BPE as in FIG. 4. Although, in this specific example, a conventional approach produced the same results as one embodiment of the invention, this will not occur in every case and it is expected that an embodiment of the invention will consistently produce better results than will result from conventional approaches.

It is noted that, if instead of matching to the previously mentioned internal study, an embodiment of the invention were used to match the same set of 1000 ‘transformer architecture’ papers to a document detailing Zero-Trust efforts, such embodiment may obtain the document ‘Trust Management for Internet of Things: A Systematic Literature Review’ (Konsta, A. M., Lafuente, A. L. and Dragoni, N., 2022. Trust Management for Internet of Things: A Systematic Literature Review. arXiv preprint arXiv:2211.01712) as the best match, again with both BPE and preprocessing.

Despite being the best match, this paper is extremely recent and was first put on arXiv on Nov. 3, 2022, making it harder to find through other search platforms that might not have even indexed it yet. The paper discusses the state of the art applications for defining and monitoring trust levels in Internet-of-Things network nodes, seen through the lens of a layered process. These concepts and vocabulary are useful and relevant to Zero-Trust discussions and potential inventions, even though the words ‘Zero-Trust’ don't occur directly in the paper.

This example shows that an embodiment of the invention may serve as an assistive tool to users to quickly find relevant references that may aid their creative IP production process, whereas the references in question might be otherwise not found. It is also worth noting that, although this experiment used the arXiv search API due to its convenient implementation, this approach could be extended to other search APIs, both external to an enterprise, and internal to the enterprise.

### F. EXAMPLE METHODS

It is noted with respect to the disclosed methods, including the example methods of FIGS. 1 and 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In an embodiment, the methods of FIG. 1 and/or FIG. 2 may be performed by a stand-alone, dedicated, platform comprising a computing device. The methods may be performed at a local site that has access to online APIs, but is able to perform other operations in a secure manner that does not expose those operations, or related data, to outside systems and entities. Parts, or all, of the methods may be performed at the direction of users such as researchers and scientists. Finally, the methods may be performed automatically upon receipt of user input such as, but not limited to, reference information such as a reference document, and a corpus of documents. In one embodiment, a user may provide a query to obtain a corpus of documents.

### G. FURTHER EXAMPLE EMBODIMENTS

Following are some further example embodiments of the invention. These are presented only by way of example and are not intended to limit the scope of the invention in any way.

Embodiment 1. A method, comprising: receiving input from a user, the input comprising reference information, and a document corpus that comprises a group of documents; performing a byte pair encoding (BPE) process, and/or preprocessing, on the documents in the document corpus, so as to generate a respective TDF-IDF (term frequency-inverse document frequency) vector for each of the documents in the document corpus; comparing each of the TDF-IDF vectors to the reference information; and based on the comparing, ranking the documents according to their respective relevance to the reference information.

Embodiment 2. The method as recited in embodiment 1, wherein the preprocessing comprises any one or more of tokenization, cleaning, and stemming.

Embodiment 3. The method as recited in embodiment 1, wherein the BPE process produces a vocabulary comprising a group of symbols, and each symbol is assigned a numerical index.

Embodiment 4. The method as recited in embodiment 1, wherein the reference information comprises a document.

Embodiment 5. The method as recited in embodiment 1, wherein the document corpus is obtained using an online application program interface (API) to query an internet search engine.

Embodiment 6. The method as recited in embodiment 1, wherein the comparing is performed using a similarity metric.

Embodiment 7. The method as recited in embodiment 1, wherein the document corpus is obtained using an external internet search engine, and the performing, the comparing, and the ranking, are performed at a secure internal site.

Embodiment 8. The method as recited in embodiment 1, wherein the performing, the comparing, and the ranking, are performed as part of an artificial intelligence/machine learning method.

Embodiment 9. The method as recited in embodiment 1, wherein the BPE process includes performing, by a tokenizer subroutine, natural language processing on the documents in the document corpus.

Embodiment 10. The method as recited in embodiment 1, wherein the BPE is performed based on a vocabulary hyperparameter provided by the user.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

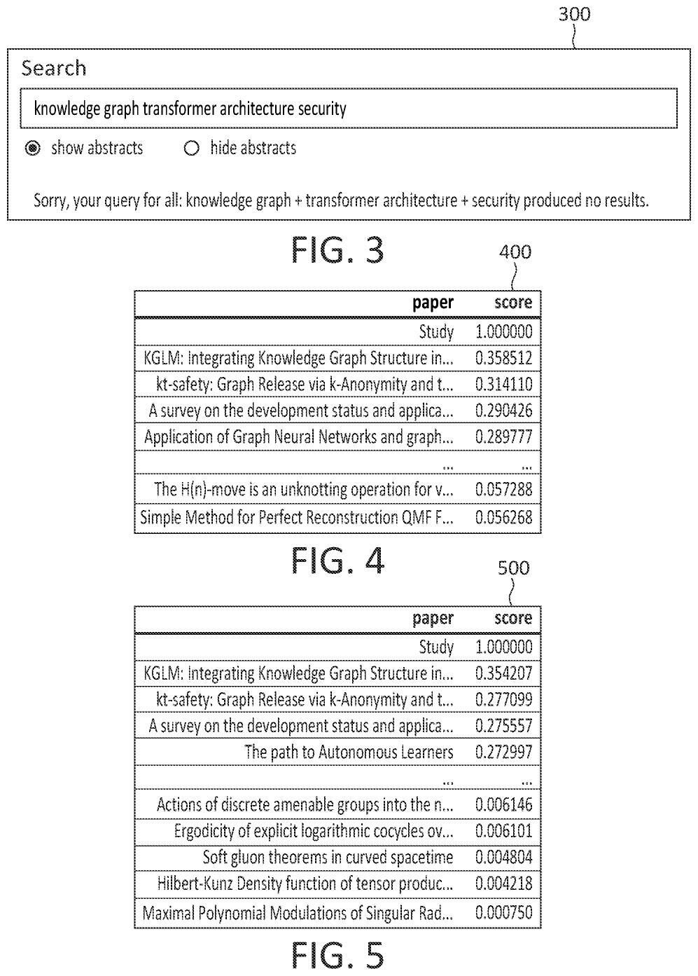

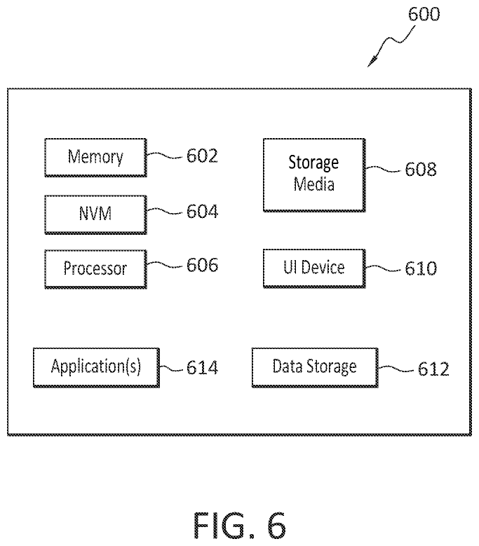

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 602 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving input from a user, the input comprising reference information, and a document corpus that comprises a group of documents;
performing a byte pair encoding (BPE) process, and/or preprocessing, on the documents in the document corpus, so as to generate a respective TDF-IDF (term frequency-inverse document frequency) vector for each of the documents in the document corpus;
comparing each of the TDF-IDF vectors to the reference information; and
based on the comparing, displaying the documents based on matches to the reference information in a descending order.

2. The method as recited in claim 1, wherein the preprocessing comprises any one or more of tokenization, cleaning, and stemming.

3. The method as recited in claim 1, wherein the BPE process produces a vocabulary comprising a group of symbols, and each symbol is assigned a numerical index.

4. The method as recited in claim 1, wherein the reference information comprises a document.

5. The method as recited in claim 1, wherein the document corpus is obtained using an online application program interface (API) to query an internet search engine.

6. The method as recited in claim 1, wherein the comparing is performed using a similarity metric.

7. The method as recited in claim 1, wherein the document corpus is obtained using an external internet search engine, and the performing, the comparing, and the ranking, are performed at a secure internal site.

8. The method as recited in claim 1, wherein the performing, the comparing, and the ranking, are performed as part of an artificial intelligence/machine learning method.

9. The method as recited in claim 1, wherein the BPE process includes performing, by a tokenizer subroutine, natural language processing on the documents in the document corpus.

10. The method as recited in claim 1, wherein the BPE is performed based on a vocabulary hyperparameter provided by the user.

11. A non-transitory storage medium having stored therein instructions that are executable by one or more hardware processors to perform operations comprising:
receiving input from a user, the input comprising reference information, and a document corpus that comprises a group of documents;
performing a byte pair encoding (BPE) process, and/or preprocessing, on the documents in the document corpus, so as to generate a respective TDF-IDF (term frequency-inverse document frequency) vector for each of the documents in the document corpus;
comparing each of the TDF-IDF vectors to the reference information; and
based on the comparing, displaying the documents based on matches to the reference information in a descending order.

12. The non-transitory storage medium as recited in claim 11, wherein the preprocessing comprises any one or more of tokenization, cleaning, and stemming.

13. The non-transitory storage medium as recited in claim 11, wherein the BPE process produces a vocabulary comprising a group of symbols, and each symbol is assigned a numerical index.

14. The non-transitory storage medium as recited in claim 11, wherein the reference information comprises a document.

15. The non-transitory storage medium as recited in claim 11, wherein the document corpus is obtained using an online application program interface (API) to query an internet search engine.

16. The non-transitory storage medium as recited in claim 11, wherein the comparing operation is performed using a similarity metric.

17. The non-transitory storage medium as recited in claim 11, wherein the document corpus is obtained using an external internet search engine, and the performing operation, the comparing operation, and the ranking operation, are performed at a secure internal site.

18. The non-transitory storage medium as recited in claim 11, wherein the performing operation, the comparing operation, and the ranking operation, are performed as part of an artificial intelligence/machine learning method.

19. The non-transitory storage medium as recited in claim 11, wherein the BPE process includes performing, by a tokenizer subroutine, natural language processing on the documents in the document corpus.

20. The non-transitory storage medium as recited in claim 11, wherein the BPE is performed based on a vocabulary hyperparameter provided by the user.
